(19) United States
(12) Patent Application Publication
(10) Pub. No.: US 2024/0357586 A1
(43) Pub. Date: Oct. 24, 2024

(54) JOINT CHANNEL ESTIMATION FOR MULTIPLE TRANSPORT BLOCKS

(71) Applicant: Panasonic Intellectual Property Corporation of America, Torrance, CA (US)

(72) Inventors: Xuan Tuong TRAN, Singapore (SG); Hidetoshi SUZUKI, Kanagawa (JP); Hong Cheng, Michael SIM, Singapore (SG); Yang KANG, Singapore (SG); Yoshihiko OGAWA, Kanagawa (JP)

(21) Appl. No.: 18/685,785

(22) PCT Filed: Jul. 22, 2022
(86) PCT No.: PCT/SG2022/050525

§ 371 Date: Feb. 22, 2024

(30) Foreign Application Priority Data
Aug. 27, 2021 (SG) 10202109370S

(51) Int. Cl. H04W 72/1268; H04L 5/00; H04L 25/02; H04W 72/0446

(52) U.S. Cl. CPC H04W 72/1268; H04L 5/0048; H04L 25/0204; H04W 72/0446

(57) ABSTRACT

Communication apparatuses and methods for providing multiple structures and methods to enable joint channel estimation scheduled by multiple control information are provided. The techniques disclosed here feature a communication apparatus including a transceiver and circuitry. The transceiver, in operation, receives control information triggering joint channel estimation across multiple transport blocks. The circuitry, in operation, determines one or more time domain windows for physical uplink shared channel (PUSCH) transmissions of the multiple transport block, and the transceiver, which in operation, transmits reference signals based on the one or more time domain windows.

### BACKGROUND

### 1. Technical Field

The present disclosure relates generally to radio access network (RAN) communication, and more particularly relates to communication apparatuses and communication methods for enabling joint channel estimation for multiple transport blocks (TBs).

### 2. Description of the Related Art

Communication apparatuses are prevalent in today's world in the form of phones, tablets, computers, cameras, digital audio/video players, wearable devices, game consoles, telehealth/telemedicine devices, and vehicles providing communication functionality, and various combinations thereof. The communication may include exchanging data through, for example, a cellular system, a satellite system, a wireless local area network system, and various combinations thereof.

In practical deployments of cellular networks, coverage is one of the key factors when commercializing cellular communication networks due to its direct impact on service quality, capital expenditures, and operating expenses. Compared to Long-Term Evolution (LTE) or 3G, many countries around the world are offering available more spectrum in frequency range 1 (FR1), such as 3.5 GHz, to operate 5G (Fifth Generation NR). This FR1 is typically in higher frequencies than that used for LTE or 3G. In addition, 5G NR is also designed to operate at much higher frequencies in frequency range 2 (FR2), such as 28 GHz or 39 GHz. Due to the higher frequencies, it is inevitable that the wireless channel will be subject to higher path-loss such that it is more challenging to maintain an adequate quality of service that is at least equal to that of legacy radio access technologies (RATs). One key user equipment (UE) application of particular importance is voice service for which a typical subscriber will always expect ubiquitous coverage wherever it is located.

In current communication specifications such as evolved UTRA (Universal Terrestrial Radio Access) or 5G NR, the physical layer of the radio interface for such communication, such as Interfaces for User Equipment, Evolved Universal Terrestrial Radio Access Networks (Evolved UTRAN) and NG-RAN (Next Generation-Radio Access Network), joint channel estimation is only applicable for PUSCH (Physical Uplink Shared Channel) transmissions of the same Transport Block for either PUSCH repetition type A or PUSCH repetition type B, but not for both types. This is also true for channel estimation in PUCCH (Physical Uplink Control Channel) transmissions, PDCCH (Physical Downlink Control Channel) transmissions, and PDSCH (Physical Downlink Shared Channel) transmissions.

Joint channel estimation means that demodulation reference signal (DMRS) symbols are jointly used for channel estimation, including cross-slot channel estimation over consecutive slots, cross-slot channel estimation over non-consecutive slots, cross-repetition channel estimation within one slot, and inter-slot frequency hopping with inter-slot bundling to enable cross-slot channel estimation. Hence, joint channel estimation is also known as DMRS bundling. There are many aspects that can impact performance of joint channel estimation such as power transmission/reception, different phases, and locations of DMRS symbols.

It has not been concluded how to design and enable joint channel estimation for PUSCH transmissions with different transport blocks. The RAN1 technical specification group responsible for specification of such physical layers has indicated the issue of back-to-back PUSCH transmissions with different transport blocks is for further study (see RAN1 #1004b-e)

For back-to-back PUSCH transmissions across consecutive slots, support necessary design aspects (under the condition of power consistency and phase continuity) to enable joint channel estimation has been provided by RAN1 for back-to-back PUSCH transmissions (of the same transport block) for repetition type B scheduled by dynamic grant or configured grant, if it reuses only those joint channel estimation specification enhancements defined to support repetition Type A and only for single layer transmissions subject to user equipment capability.

Thus, there is a need for communication apparatuses and communication methods for joint channel estimation to alleviate the aforementioned issues by enabling joint channel estimation for multiple transport blocks. Furthermore, other desirable features and characteristics will become apparent from the subsequent detailed description and the appended claims, taken in conjunction with the accompanying drawings and this background.

### SUMMARY

One non-limiting and exemplary embodiment facilitates providing multiple structures and methods to enable joint channel estimation scheduled by multiple control information.

In an embodiment, the techniques disclosed herein feature a communication apparatus including a transceiver and circuitry. The transceiver, in operation, receives control information triggering joint channel estimation across multiple transport blocks. The circuitry, in operation, determines one or more time domain windows for physical uplink shared channel (PUSCH) transmissions of the multiple transport block, and the transceiver, which in operation, transmits reference signals based on the one or more time domain windows.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE FIGURES

In the following, exemplary embodiments are described in more detail with reference to the attached figures and drawings.

FIG. 1 shows an exemplary architecture for a 3GPP NR system;

FIG. 2 is a schematic illustration which shows functional split between NG-RAN and 5GC;

FIG. 3 is a sequence diagram for RRC connection setup/reconfiguration procedures;

FIG. 4 is a schematic illustration showing usage scenarios of Enhanced mobile broadband (eMBB), Massive Machine Type Communications (mMTC) and Ultra Reliable Low Latency Communications (URLLC);

FIG. 5 is a block diagram showing an exemplary 5G system architecture for a non-roaming scenario;

FIG. 6 illustrates joint channel estimation applied for multiple transport blocks scheduled by multiple downlink control information (DCIs) where one of multiple DCIs is mis-detected or false-detected;

FIG. 7 depicts a block diagram of an exemplary communication apparatus;

FIG. 8 illustrates definition of two actual time domain windows in response to mis-detected or false-detected downlink control information (DCI) in accordance with the present disclosure;

FIG. 9 illustrates a flowchart for joint channel estimation across multiple transport blocks in accordance with a first embodiment of the present disclosure;

FIG. 10 illustrates definition of an actual time domain window determined based on a subset combination of a total number of PUSCH transmissions from transport blocks scheduled by successfully detected DCIs in accordance with the present disclosure;

FIG. 11 illustrates definition of an actual time domain window determined based on multiple repetitions of transport blocks scheduled by successfully detected DCIs in accordance with the present disclosure;

FIG. 12 illustrates indication of joint channel estimation across multiple transport blocks for user equipment using the two-step DCI procedure in accordance with the present disclosure;

FIG. 13 depicts a flowchart of joint channel estimation across multiple transport blocks based on an indication in the two-step DCI in accordance with the present disclosure;

FIG. 14A depicts a bit-field PUSCH time domain resource allocation (TDRA) definition in accordance with the present disclosure and FIG. 14B depicts an enhanced TDRA Table in accordance with the present disclosure;

And FIG. 15 illustrates multiple repetitions of transport blocks scheduled by a two-step PDCCH within an actual time domain window in accordance with the present disclosure.

Skilled artisans will appreciate that elements in the figures are illustrated for simplicity and clarity and have not necessarily been depicted to scale.

### DETAILED DESCRIPTION

The following detailed description is merely exemplary in nature and is not intended to limit the exemplary embodiments or the application and uses of the exemplary embodiments. Furthermore, there is no intention to be bound by any theory presented in the preceding background or the following detailed description.

### 5G NR System Architecture and Protocol Stacks

3GPP has been working at the next release for the 5^{th} generation cellular technology, simply called 5G, including the development of a new radio access technology (NR) operating in frequencies ranging up to 100 GHz. The first version of the 5G standard was completed at the end of 2017, which allows proceeding to 5G NR standard-compliant trials and commercial deployments of smartphones.

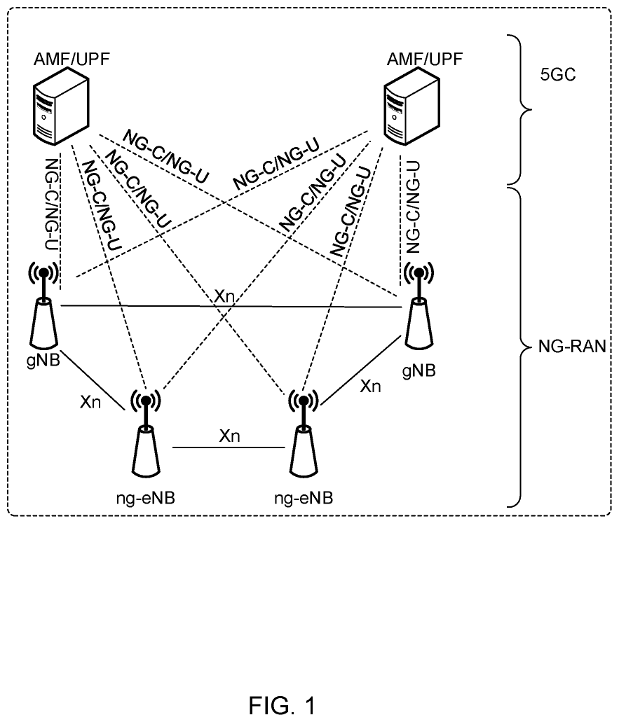

Among other things, the overall system architecture assumes an NG-RAN (Next Generation-Radio Access Network) that comprises gNBs, providing the NG-radio access user plane (SDAP/PDCP/RLC/MAC/PHY) and control plane (RRC) protocol terminations towards the UE. The gNBs are interconnected with each other by means of the Xn interface. The gNBs are also connected by means of the Next Generation (NG) interface to the NGC (Next Generation Core), more specifically to the AMF (Access and Mobility Management Function) (e.g. a particular core entity performing the AMF) by means of the NG-C interface and to the UPF (User Plane Function) (e.g. a particular core entity performing the UPF) by means of the NG-U interface. The NG-RAN architecture is illustrated in FIG. 1 (see e.g. 3GPP TS 38.300 v15.6.0, section 4).

The user plane protocol stack for NR (see e.g. 3GPP TS 38.300, section 4.4.1) comprises the PDCP (Packet Data Convergence Protocol, see section 6.4 of TS 38.300), RLC (Radio Link Control, see section 6.3 of TS 38.300) and MAC (Medium Access Control, see section 6.2 of TS 38.300) sublayers, which are terminated in the gNB on the network side. Additionally, a new access stratum (AS) sublayer (SDAP, Service Data Adaptation Protocol) is introduced above PDCP (see e.g. sub-clause 6.5 of 3GPP TS 38.300). A control plane protocol stack is also defined for NR (see for instance TS 38.300, section 4.4.2). An overview of the Layer 2 functions is given in sub-clause 6 of TS 38.300. The functions of the PDCP, RLC and MAC sublayers are listed respectively in sections 6.4, 6.3, and 6.2 of TS 38.300. The functions of the RRC layer are listed in sub-clause 7 of TS 38.300.

For instance, the Medium-Access-Control layer handles logical-channel multiplexing, and scheduling and scheduling-related functions, including handling of different numerologies.

The physical layer (PHY) is for example responsible for coding, PHY HARQ processing, modulation, multi-antenna processing, and mapping of the signal to the appropriate physical time-frequency resources. It also handles mapping of transport channels to physical channels. The physical layer provides services to the MAC layer in the form of transport channels. A physical channel corresponds to the set of time-frequency resources used for transmission of a particular transport channel, and each transport channel is mapped to a corresponding physical channel. For instance, the physical channels are PRACH (Physical Random Access Channel), PUSCH (Physical Uplink Shared Channel) and PUCCH (Physical Uplink Control Channel) for uplink and PDSCH (Physical Downlink Shared Channel), PDCCH (Physical Downlink Control Channel) and PBCH (Physical Broadcast Channel) for downlink.

Use cases/deployment scenarios for NR could include enhanced mobile broadband (eMBB), ultra-reliable low-latency communications (URLLC), massive machine type communication (mMTC), which have diverse requirements in terms of data rates, latency, and coverage. For example, eMBB is expected to support peak data rates (20 Gbps for downlink and 10 Gbps for uplink) and user-experienced data rates in the order of three times what is offered by IMT-Advanced. On the other hand, in case of URLLC, the tighter requirements are put on ultra-low latency (0.5 ms for UL and DL each for user plane latency) and high reliability (1-10⁻⁵ within 1 ms). Finally, mMTC may preferably require high connection density (1,000,000 devices/km² in an urban environment), large coverage in harsh environments, and extremely long-life battery for low cost devices (15 years).

Therefore, the OFDM numerology (e.g. subcarrier spacing, OFDM symbol duration, cyclic prefix (CP) duration, number of symbols per scheduling interval) that is suitable for one use case might not work well for another. For example, low-latency services may preferably require a shorter symbol duration (and thus larger subcarrier spacing) and/or fewer symbols per scheduling interval (aka, TTI) than an mMTC service. Furthermore, deployment scenarios with large channel delay spreads may preferably require a longer CP duration than scenarios with short delay spreads. The subcarrier spacing should be optimized accordingly to retain the similar CP overhead. NR may support more than one value of subcarrier spacing. Correspondingly, subcarrier spacing of 15 kHz, 30 kHz, 60 kHz . . . are being considered at the moment. The symbol duration Tᵤ and the subcarrier spacing Δf are directly related through the formula Δf=1/Tᵤ. In a similar manner as in LTE systems, the term “resource element” can be used to denote a minimum resource unit being composed of one subcarrier for the length of one OFDM/SC-FDMA symbol.

In the new radio system 5G-NR for each numerology and carrier a resource grid of subcarriers and OFDM symbols is defined respectively for uplink and downlink. Each element in the resource grid is called a resource element and is identified based on the frequency index in the frequency domain and the symbol position in the time domain (see 3GPP TS 38.211 v15.6.0).

### 5G NR Functional Split Between NG-RAN and 5GC

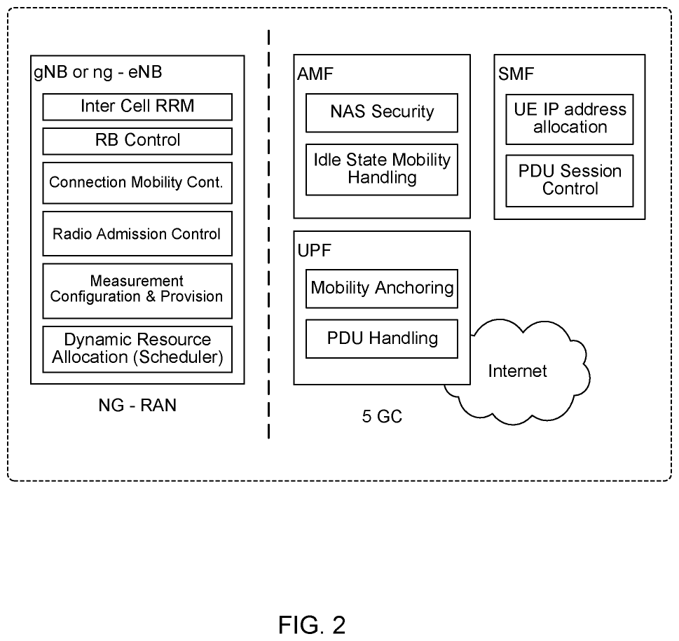

FIG. 2 illustrates functional split between NG-RAN and 5GC. NG-RAN logical node is a gNB or ng-eNB. The 5GC has logical nodes AMF, UPF and SMF.

In particular, the gNB and ng-eNB host the following main functions:
Functions for Radio Resource Management such as Radio Bearer Control, Radio Admission Control, Connection Mobility Control, Dynamic allocation of resources to UEs in both uplink and downlink (scheduling);
IP header compression, encryption and integrity protection of data;
Selection of an AMF at UE attachment when no routing to an AMF can be determined from the information provided by the UE;
Routing of User Plane data towards UPF(s);
Routing of Control Plane information towards AMF;
Connection setup and release;
Scheduling and transmission of paging messages;
Scheduling and transmission of system broadcast information (originated from the AMF or OAM);
Measurement and measurement reporting configuration for mobility and scheduling;
Transport level packet marking in the uplink;
Session Management;
Support of Network Slicing;
QoS Flow management and mapping to data radio bearers;
Support of UEs in RRC_INACTIVE state;
Distribution function for NAS messages;
Radio access network sharing;
Dual Connectivity;
Tight interworking between NR and E-UTRA.

The Access and Mobility Management Function (AMF) hosts the following main functions:
Non-Access Stratum, NAS, signaling termination;
NAS signaling security;
Access Stratum, AS, Security control;
Inter Core Network, CN, node signaling for mobility between 3GPP access networks;
Idle mode UE Reachability (including control and execution of paging retransmission);
Registration Area management;
Support of intra-system and inter-system mobility;
Access Authentication;
Access Authorization including check of roaming rights;
Mobility management control (subscription and policies);
Support of Network Slicing;
Session Management Function, SMF, selection.

Furthermore, the User Plane Function, UPF, hosts the following main functions:
Anchor point for Intra-/Inter-RAT mobility (when applicable);
External PDU session point of interconnect to Data Network;
Packet routing & forwarding;
Packet inspection and User plane part of Policy rule enforcement;
Traffic usage reporting;
Uplink classifier to support routing traffic flows to a data network;
Branching point to support multi-homed PDU session;
QoS handling for user plane, e.g. packet filtering, gating, UL/DL rate enforcement;
Uplink Traffic verification (SDF to QoS flow mapping);
Downlink packet buffering and downlink data notification triggering.

Finally, the Session Management function, SMF, hosts the following main functions:
Session Management;
UE IP address allocation and management;
Selection and control of UP function;
Configures traffic steering at User Plane Function, UPF, to route traffic to proper destination;
Control part of policy enforcement and QoS;
Downlink Data Notification.

### RRC Connection Setup and Reconfiguration Procedures

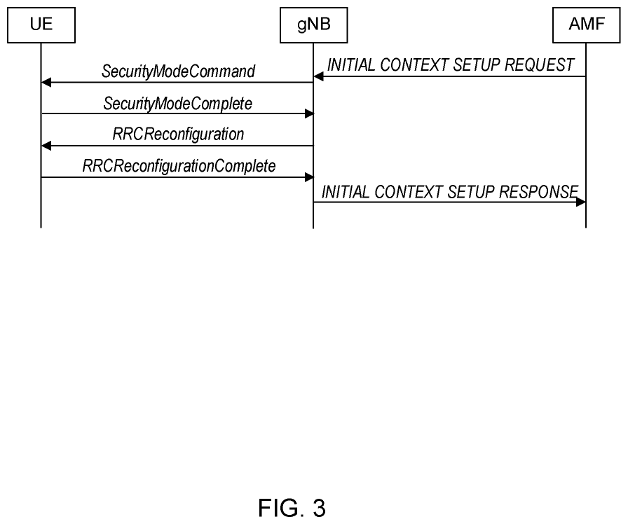

FIG. 3 illustrates some interactions between a UE, gNB, and AMF (an 5GC entity) in the context of a transition of the UE from RRC_IDLE to RRC_CONNECTED for the NAS part (see TS 38.300 v15.6.0).

RRC is a higher layer signaling (protocol) used for UE and gNB configuration. In particular, this transition involves that the AMF prepares the UE context data (including e.g. PDU session context, the Security Key, UE Radio Capability and UE Security Capabilities, etc.) and sends it to the gNB with the INITIAL CONTEXT SETUP REQUEST. Then, the gNB activates the AS security with the UE, which is performed by the gNB transmitting to the UE a SecurityModeCommand message and by the UE responding to the gNB with the SecurityModeComplete message. Afterwards, the gNB performs the reconfiguration to setup the Signaling Radio Bearer 2, SRB2, and Data Radio Bearer(s), DRB(s) by means of transmitting to the UE the RRCReconfiguration message and, in response, receiving by the gNB the RRCReconfigurationComplete from the UE. For a signaling-only connection, the steps relating to the RRCReconfiguration are skipped since SRB2 and DRBs are not setup. Finally, the gNB informs the AMF that the setup procedure is completed with the INITIAL CONTEXT SETUP RESPONSE.

In the present disclosure, thus, an entity (for example AMF, SMF, etc.) of a 5th Generation Core (5GC) is provided that comprises control circuitry which, in operation, establishes a Next Generation (NG) connection with a gNodeB, and a transmitter which, in operation, transmits an initial context setup message, via the NG connection, to the gNodeB to cause a signaling radio bearer setup between the gNodeB and a user equipment (UE). In particular, the gNodeB transmits a Radio Resource Control, RRC, signaling containing a resource allocation configuration information element to the UE via the signaling radio bearer. The UE then performs an uplink transmission or a downlink reception based on the resource allocation configuration.

### Usage Scenarios of IMT for 2020 and Beyond

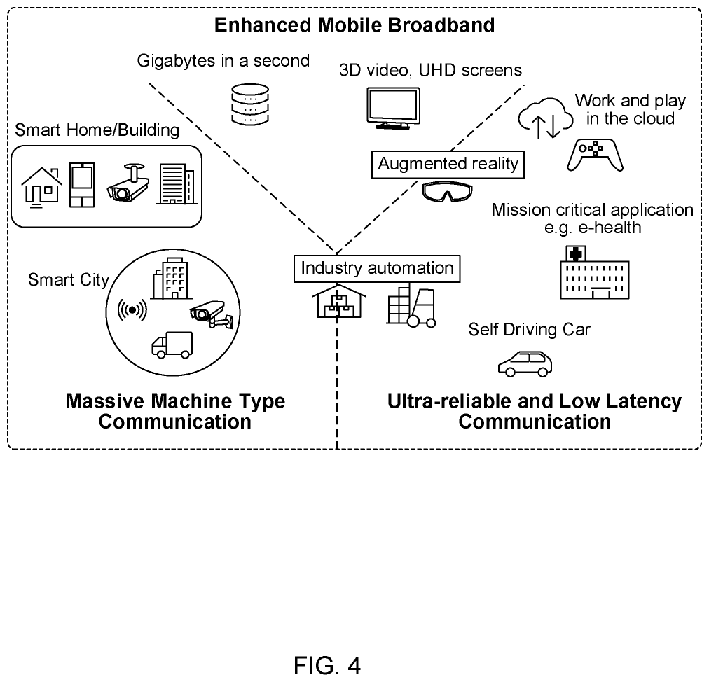

FIG. 4 illustrates some of the use cases for 5G NR. In 3rd generation partnership project new radio (3GPP NR), three use cases are being considered that have been envisaged to support a wide variety of services and applications by IMT-2020. The specification for the phase 1 of enhanced mobile-broadband (eMBB) has been concluded. In addition to further extending the eMBB support, the current and future work would involve the standardization for ultra-reliable and low-latency communications (URLLC) and massive machine-type communications. FIG. 4 illustrates some examples of envisioned usage scenarios for IMT for 2020 and beyond (see e.g. ITU-R M.2083 FIG. 2).

The URLLC use case has stringent requirements for capabilities such as throughput, latency and availability and has been envisioned as one of the enablers for future vertical applications such as wireless control of industrial manufacturing or production processes, remote medical surgery, distribution automation in a smart grid, transportation safety, etc. Ultra-reliability for URLLC is to be supported by identifying the techniques to meet the requirements set by TR 38.913. For NR URLLC in Release 15, key requirements include a target user plane latency of 0.5 ms for UL (uplink) and 0.5 ms for DL (downlink). The general URLLC requirement for one transmission of a packet is a BLER (block error rate) of 1E-5 for a packet size of 32 bytes with a user plane latency of 1 ms.

From the physical layer perspective, reliability can be improved in a number of possible ways. The current scope for improving the reliability involves defining separate CQI tables for URLLC, more compact DCI formats, repetition of PDCCH, etc. However, the scope may widen for achieving ultra-reliability as the NR becomes more stable and developed (for NR URLLC key requirements). Particular use cases of NR URLLC in Rel. 15 include Augmented Reality/Virtual Reality (AR/VR), e-health, e-safety, and mission-critical applications.

Moreover, technology enhancements targeted by NR URLLC aim at latency improvement and reliability improvement. Technology enhancements for latency improvement include configurable numerology, non slot-based scheduling with flexible mapping, grant free (configured grant) uplink, slot-level repetition for data channels, and downlink pre-emption. Pre-emption means that a transmission for which resources have already been allocated is stopped, and the already allocated resources are used for another transmission that has been requested later, but has lower latency/higher priority requirements. Accordingly, the already granted transmission is pre-empted by a later transmission. Pre-emption is applicable independent of the particular service type. For example, a transmission for a service-type A (URLLC) may be pre-empted by a transmission for a service type B (such as eMBB). Technology enhancements with respect to reliability improvement include dedicated CQI/MCS tables for the target BLER of 1E-5.

The use case of mMTC (massive machine type communication) is characterized by a very large number of connected devices typically transmitting a relatively low volume of non-delay sensitive data. Devices are required to be low cost and to have a very long battery life. From NR perspective, utilizing very narrow bandwidth parts is one possible solution to have power saving from UE perspective and enable long battery life.

As mentioned above, it is expected that the scope of reliability in NR becomes wider. One key requirement to all the cases, and especially necessary for URLLC and mMTC, is high reliability or ultra-reliability. Several mechanisms can be considered to improve the reliability from radio perspective and network perspective. In general, there are a few key potential areas that can help improve the reliability. Among these areas are compact control channel information, data/control channel repetition, and diversity with respect to frequency, time and/or the spatial domain. These areas are applicable to reliability in general, regardless of particular communication scenarios.

For NR URLLC, further use cases with tighter requirements have been identified such as factory automation, transport industry and electrical power distribution, including factory automation, transport industry, and electrical power distribution. The tighter requirements are higher reliability (up to 10⁻⁶ level), higher availability, packet sizes of up to 256 bytes, time synchronization down to the order of a few μs where the value can be one or a few μs depending on frequency range and short latency in the order of 0.5 to 1 ms in particular a target user plane latency of 0.5 ms, depending on the use cases.

Moreover, for NR URLLC, several technology enhancements from the physical layer perspective have been identified. Among these are PDCCH (Physical Downlink Control Channel) enhancements related to compact DCI, PDCCH repetition, increased PDCCH monitoring. Moreover, UCI (Uplink Control Information) enhancements are related to enhanced HARQ (Hybrid Automatic Repeat Request) and CSI feedback enhancements. Also PUSCH enhancements related to mini-slot level hopping and retransmission/repetition enhancements have been identified. The term “mini-slot” refers to a Transmission Time Interval (TTI) including a smaller number of symbols than a slot (a slot comprising fourteen symbols).

### QoS Control

The 5G QoS (Quality of Service) model is based on QoS flows and supports both QoS flows that require guaranteed flow bit rate (GBR QoS flows) and QoS flows that do not require guaranteed flow bit rate (non-GBR QoS Flows). At NAS level, the QoS flow is thus the finest granularity of QoS differentiation in a PDU session. A QoS flow is identified within a PDU session by a QoS flow ID (QFI) carried in an encapsulation header over NG-U interface.

For each UE, 5GC establishes one or more PDU Sessions. For each UE, the NG-RAN establishes at least one Data Radio Bearers (DRB) together with the PDU Session, and additional DRB(s) for QoS flow(s) of that PDU session can be subsequently configured (it is up to NG-RAN when to do so), e.g. as shown above with reference to FIG. 3. The NG-RAN maps packets belonging to different PDU sessions to different DRBs. NAS level packet filters in the UE and in the 5GC associate UL and DL packets with QoS Flows, whereas AS-level mapping rules in the UE and in the NG-RAN associate UL and DL QoS Flows with DRBs.

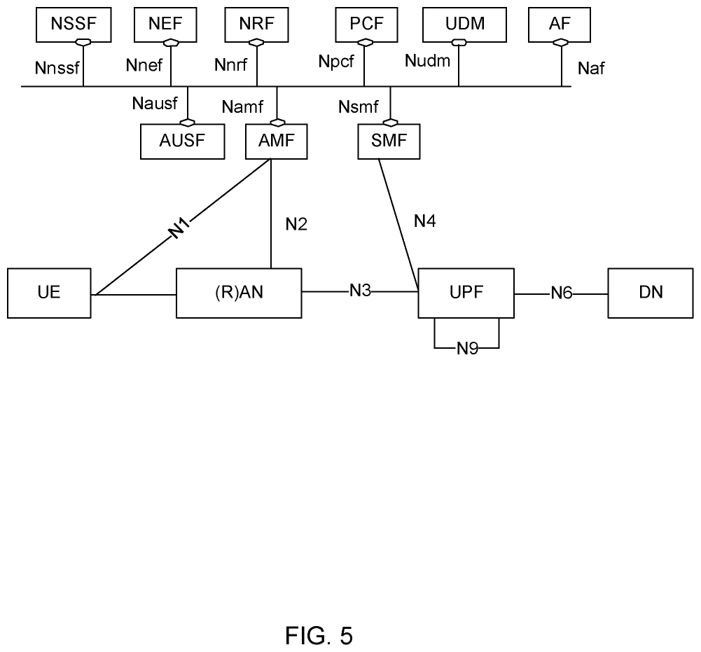

FIG. 5 illustrates a 5G NR non-roaming reference architecture (see TS 23.501 v16.1.0, section 4.23). An Application Function (AF), e.g. an external application server hosting 5G services, exemplarily described in FIG. 4, interacts with the 3GPP Core Network in order to provide services, for example to support application influence on traffic routing, accessing Network Exposure Function (NEF) or interacting with the Policy framework for policy control (see Policy Control Function, PCF), e.g. QoS control. Based on operator deployment, Application Functions considered to be trusted by the operator can be allowed to interact directly with relevant Network Functions. Application Functions not allowed by the operator to access directly the Network Functions use the external exposure framework via the NEF to interact with relevant Network Functions.

FIG. 5 shows further functional units of the 5G architecture, namely Network Slice Selection Function (NSSF), Network Repository Function (NRF), Unified Data Management (UDM), Authentication Server Function (AUSF), Access and Mobility Management Function (AMF), Session Management Function (SMF), and Data Network (DN), e.g. operator services, Internet access or 3rd party services. All of or a part of the core network functions and the application services may be deployed and running on cloud computing environments.

In the present disclosure, thus, an application server (for example, AF of the 5G architecture), is provided that comprises a transmitter, which, in operation, transmits a request containing a QoS requirement for at least one of URLLC, eMMB and mMTC services to at least one of functions (for example NEF, AMF, SMF, PCF,UPF, etc) of the 5GC to establish a PDU session including a radio bearer between a gNodeB and a UE in accordance with the QoS requirement and control circuitry, which, in operation, performs the services using the established PDU session.

### Embodiments

It is the intent of the present disclosure to present exemplary embodiments of communication apparatuses and communication methods for joint channel estimation by enabling joint channel estimation for multiple transport blocks scheduled by multiple control information (e.g., downlink control information or uplink control information) to conserve power by reducing channel monitoring, increase reliability by providing quick response in case of control information failure (e.g., missed control information), and achieve gain in coverage enhancement.

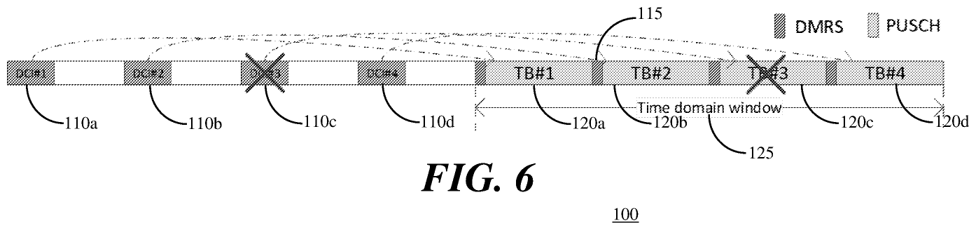

Joint channel estimation means that demodulation reference signal (DMRS) symbols are jointly used for channel estimation, including cross-slot channel estimation over consecutive slots, cross-slot channel estimation over non-consecutive slots, cross-repetition channel estimation within one slot, and inter-slot frequency hopping with inter-slot bundling to enable cross-slot channel estimation. The issue in joint channel estimation is how to enable joint channel estimation for multiple transport blocks scheduled by multiple control information symbols. Referring to FIG. 6, an illustration 100 depicts an exemplary signal where multiple downlink control information (DCI) 110a, 110b, 110c 110d are received in between demodulation reference signal symbols 115 as joint channel estimation for scheduling multiple transport blocks (TB) 120a, 120b, 120c, 120d within a nominal time domain window 125 on a physical layer uplink shared channel (PUSCH) 130. If at least one of the multiple downlink control information 110a, 110b, 110c 110d is mis-detected or false-detected, the actual length of the time domain window 125 for enabling joint channel estimation varies, requiring the base station to do blind detection of the actual length of the time domain window 125. To enable such blind detection significantly increases the complexity of the operation of the base station.

Also, if at least one of the multiple transport blocks is not able to be transmitted, the base station cannot use the demodulation reference signal symbol 115 of that transport block (e.g., demodulation reference signal symbol 115 before TB #3 110c) so that the base station cannot perform joint channel estimation over the multiple transport blocks. FIG. 6 illustrates that when DCI #3 110c is mis-detected or false-detected, the base station cannot perform joint channel estimation over the four transport blocks 120a, 120b, 120c, 120d.

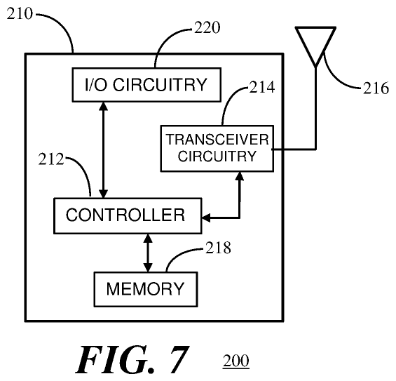

Referring to FIG. 7, a simplified block diagram 200 depicts an exemplary communication apparatus 210 such as user equipment (UE) or a base station operating a wireless communication system or gNB known as a 5G NR base station that transmits and receives communications between the user equipment and the cellular network. The communication apparatus 210 may include a device such as a controller 212 which is coupled to a wireless communication device, such as a transceiver 214, connected to an antenna 216 for performing a function of communication as described in the present disclosure. For example, the communication apparatus 210 may comprise the controller 212 that generates control signals and/or data signals which are used by the transceiver 214 to perform a communication function of the communication apparatus 210. The communication apparatus 210 may also comprise a memory 218 coupled to the controller 212 for storage of instructions and/or data for generation of the control signals and/or data signals by the controller 212. The communication apparatus 210 may also include input/output (I/O) circuitry 220 coupled to the controller 212 for receiving input of data and/or instructions for storage in the memory 218 and/or for generation of the control signals and/or data signals and for providing output of data in the form of audio, video, textual or other media.

Consider the situation where each of multiple transport blocks (TBs) are scheduled by a downlink control information (DCI) or by an activated DCI for configured grant type 2 in the uplink, where each of multiple TBs is transmitted in one or more Physical layer Uplink Shared Channel (PUSCH) transmissions. Each of the PUSCH transmissions may have a Start and Length Indicator Value (SLIV) or a set of symbols in a slot. Optionally, the PUSCH transmission may be a nominal or actual repetition for either PUSCH repetition type A or PUSCH repetition type B. In accordance with the present disclosure, when the user equipment mis-detects or false-detects any one of multiple DCIs and/or drops some uplink symbol(s)/slot(s) due to other higher priority signals or channels, such as uplink control information or a DCI for a higher priority channel, circuitry in the user equipment determines and indicates an actual time domain window for joint channel estimation across a part of multiple transport blocks in the uplink control information multiplexed with a PUSCH transmission.

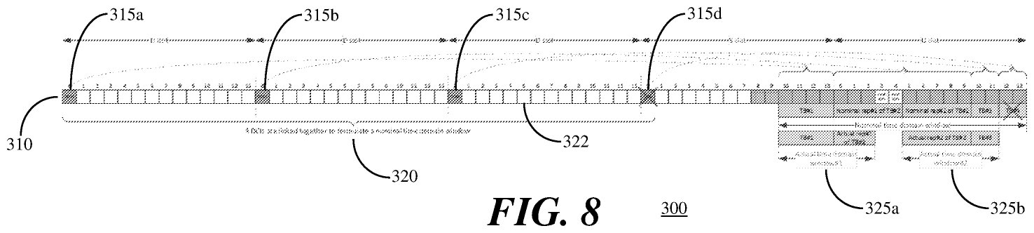

In accordance with the present disclosure, the actual time domain window indicated by the user equipment indicates a linkage among multiple downlink control information slots scheduling multiple transport blocks for a purpose of triggering joint channel estimation and is shorter than a nominal time domain window which is provided to the user equipment for such joint channel estimation. Referring to FIG. 8, an illustration 300 depicts a signal 310 having four DCI slots 315a, 315b 315c, 315d scheduling corresponding PUSCH transmissions which are linked together to form a nominal time domain window 320 (i.e., PUSCH #4 scheduled by DCI #4 is linked to PUSCH #3 scheduled by DCI #3, PUSCH #3 is linked to PUSCH #2 scheduled by DCI #2, and PUSCH #2 is linked to PUSCH #1 scheduled by DCI #1, PUSCH #1 to PUSCH #4 forming the nominal time domain window 320). The nominal time domain window 320 includes multiple non-overlapped sub-windows 322, each sub-window 322 referring to a corresponding duration of the one or more PUSCH transmissions of the same transport block scheduled by a DCI from the multiple DCIs, i.e., each sub-window corresponds to a DCI from multiple DCIs.

When the user equipment does not detect DCI #4, the user equipment circuitry drops the corresponding uplink symbols in uplink slots, and defines actual time domain windows 325a, 325b. The actual time domain windows 325a, 325b are defined to be shorter than the nominal time domain window 320. In accordance with the present disclosure, an indication of “this DCI is linked to the previous DCI for a purpose of triggering joint CE” is also sent in each downlink control information slot and, advantageously, the actual time domain windows 325a, 325b can include PUSCH transmissions from either or both PUSCH repetition type A and PUSCH repetition type B. Further, in accordance with the present disclosure, an indication of the actual time domain window(s) (e.g., the actual time domain windows 325a, 325b) also points out the PUSCH transmission(s) of the part of the multiple transport blocks which are coherent with respect to the PUSCH transmission that carries the uplink control information. As shown in the illustration 300, the UE drops some UL symbol(s)/slot(s) due to other higher priority signal/channel (e.g., uplink cancellation indication (UL CI), DCI for higher priority channel), herein for an example, symbols 3 and 4 in uplink U slot, so that it results in consecutive PUSCH transmissions and non-consecutive PUSCH transmissions with a non-zero gap between two consecutive PUSCH transmissions. Based on this, the UE determines the actual time domain windows 325a, 325b, where the actual time window 1 325a includes transport block 1 and the actual repetition 1 of transport block 2, while the actual time window 2 325b includes the actual repetition 2 of transport block 2 as well as transport block 3. The UE indicates the two actual time domain windows 325a, 325b to a base station in a UCI. There could be several methods to send the UCI. In a first method, the UE sends the UCI multiplexed in a separately earlier PUSCH transmission (such as PUSCH #0) other than PUSCH transmissions of multiple TBs. The gNB decodes PUCH #0, so it gets related information in the UCI to perform joint CE for PUSCH transmissions of multiple TBs in later operation.

In a second method, the UE sends the UCI multiplexed in the first PUSCH transmission from PUSCH transmissions of multiple TBs.

The gNB receives the first PUSCH transmission and attempts to decode it per normal operation while waiting to receive the remaining PUSCH transmissions of multiple TBs.

After decoding the first PUSCH transmission, the gNB gets related information in a UCI to perform joint channel estimation and combines DMRSs in the first PUSCH transmission and the remaining PUSCH transmissions to bundle DMRSs for joint channel estimation.

In a third method, the UE sends the UCI in a (long) PUCCH which is an earlier transmission than PUSCH transmissions of multiple TBs, where joint channel estimation is later applied for PUSCH transmissions of multiple TBs.

When the actual time domain window 325a, 325b includes at least one sub-window, it indicates in accordance with the present disclosure joint channel estimation for the transport block and the demodulation reference signal symbols in the one or more PUSCH transmissions of the same transport block are used for performing joint channel estimation. The actual time domain windows 325a, 325b can also be determined implicitly by the base station based on other signaling or other configurations, such as from the number of consecutive sub-windows where the subset of multiple DCIs are successfully detected.

Thus, joint channel estimation over the transport block 1 and the actual repetition 1 of transport block 2 is applied within the actual time domain window 1 325a and joint channel estimation over the actual repetition 2 of transport block 2 and the transport block 3 is applied within the actual time domain window 2 325b. The user equipment defining the actual time domain windows 325a, 325b and indicating the actual time domain windows 325a, 325b in the DCIs in the uplink slots in accordance with the present disclosure advantageously enables channel estimation over multiple transport blocks including either or both of PUSCH repetition type A and PUSCH repetition type B while avoiding introducing more complexity within the base station due to alleviating the need for blind detection of the actual time domain window(s). In addition, though a transport block has been mis-detected or false-detected, joint channel estimation is still performed for at least a part of the multiple transport blocks (i.e., for TB1, TB2 and TB3), so that a gain of coverage enhancement is beneficially achieved.

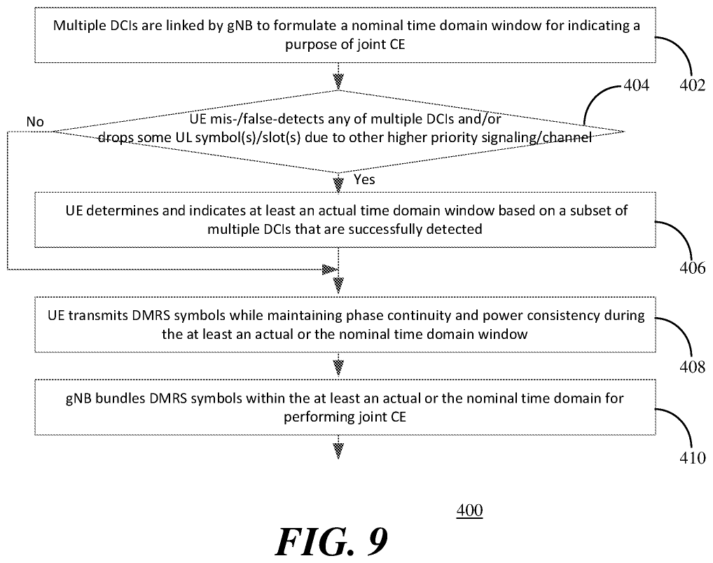

FIG. 9 depicts a flowchart 400 of the method for joint channel estimation across multiple transport blocks in accordance with the present disclosure. At step 402, multiple DCI slots 315a, 315b, 315c, 315d are linked by a base station to formulate a nominal time domain window 320 for indicating a purpose of joint channel estimation as shown in FIG. 8. At step 404 when the nominal time domain window 320 is received, the user equipment determines whether any of the multiple DCI slots 315a, 315b, 315c, 315d are mis-detected or false-detected or whether the user equipment determines to drop one or more uplink symbols or uplink slots due to a higher priority signaling or a higher priority channel. When the user equipment determines 404 mis-detection or false-detection of a DCI slot or determines to drop an uplink symbol or slot, circuitry in the user equipment defines and indicates one or more actual time domain windows at step 406 based on the subset of DCIs that are successfully detected.

Then at step 408, the user equipment transmits demodulation reference signal (DMRS) symbols while maintaining phase continuity and power consistency during the actual time window (or in the case where all multiple DCI slots are successfully received, during the nominal time window). Then, at step 410, the base station bundles the DMRS symbols within the actual or nominal time domain window for performing joint channel estimation.

At step 406, an indication of “this DCI is linked to the previous DCI for a purpose of triggering joint CE” can be sent in each downlink control information slot to indicate the actual time domain window(s). Alternatively, the radio resource control (RRC) or MAC control element is used to configure a group of multiple DCIs in a particular order. For example, an indication in each DCI which is used to indicate the index of the DCI (e.g., the radio resource control (RRC) is used to configure a group of 4 DCIs (DCI #1, DCI #2, DCI #3, DCI #4) by an indication field in each DCI is indicated as 0<=n<=3, which indicates that the DCI has the (n+1)th order within the group of 4 DCIs).

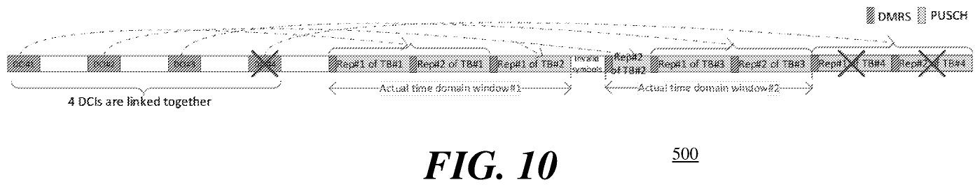

In accordance with the present disclosure, the actual time domain window may be determined based on a subset combination of a total number of PUSCH transmissions from transport blocks scheduled by successfully detected DCIs as illustrated in FIG. 10. An illustration 500 in FIG. 10 shows that the actual time domain window #1 includes two repetitions of a first transport block (TB #1) and a first repetition (repetition #1) of a second transport block (TB #2), while the actual time domain window #2 includes a second repetition (repetition #2) of the second transport block (TB #2) and two repetitions of a third transport block (TB #3). DCI #4 is mis-detected or false-detected and the invalid symbol(s) between the two actual time domain windows are symbol(s) of higher priority signals or channels.

Instead of the user equipment explicitly indicating the actual time domain window, the base station can implicitly determine the actual time domain window(s) based on the ACK/NACK of multiple DCIs in certain cases. For example, when multiple transport blocks are transmitted in only consecutive PUSCH transmissions with no gap between the consecutive PUSCH transmissions, the actual time domain window can be implicitly determined from a gap between any two consecutive PUSCH transmissions.

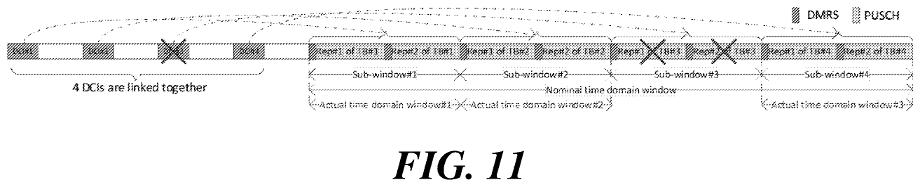

Alternatively, if any DCI is mis-detected or false-detected, joint channel estimation per transport block may be applied for the remaining transport blocks where their scheduling DCIs are successfully detected by using the DMRS symbols in the one or more PUSCH transmissions of the same transport block to perform joint channel estimation. Referring to FIG. 11, if DCI #3 is mis-detected or false-detected, joint channel estimation per transport block is applied for the remaining TB #1, TB #2, and TB #4, where each transport block is assumed to be configured with two repetitions and the actual time window includes the two repetitions.

Where there is a group of multiple DCIs arranged in a particular order, the user equipment can include successfully detected DCI (or their corresponding transport blocks) in a subset until a DCI is mis-detected or false-detected. The actual time domain can then be defined and indicated by the user equipment in accordance with the present disclosure based on the subset of DCIs. This advantageously enables joint channel estimation across transport blocks to be applied based on the subset of DCIs, and joint channel estimation per transport block to be applied for the remaining transport blocks if their scheduling DCIs are further identified as successful detections (e.g., for scheduling DCIs occurring later than the mis-detected/false-detected DCI).

For example, if there are a group of five DCIs (DCI #1, DCI #2, DCI #3, DCI #4, DCI #5) and DCI #3 is mis-detected, joint channel estimation over TB #1 and TB #2 is applied in the actual time domain window, while joint channel estimation per transport block is applied for TB #4 and for TB #5. If DCI #1 is mis-detected, joint channel estimation per transport block is applied for each of TB #2, TB #3, TB #4, and TB #5.

The solutions and variations described hereinabove may be used for the case where many PDCCHs are sent in a slot or in one PDCCH monitoring occasion for a user equipment, where each PDCCH carries a DCI, in order to reduce PDCCH monitoring frequency.

Consider next the situation where the user equipment is configured to receive two physical layer downlink control channels (PDCCHs) in a slot for performing a two-step DCI procedure. At the first step, the user equipment receives the first PDCCH that carries the first-step DCI to indicate at least a configurable payload size and/or a format of the second-step DCI. At the second step, the user equipment subsequently receives the second PDCCH in the same slot that carries the second-step DCI and at least includes details on scheduling information for multiple transport blocks in the uplink.

In accordance with the present disclosure, the user equipment determines at least a time domain window for joint channel estimation across multiple transport blocks based on an indication in the second-step DCI. The time domain resource allocation (TDRA) table is enhanced such that each row of the TDRA table indicates the start and length indicator values (SLIVs) (time-domain resources) and mapping types for multiple transport blocks that are transmitted in consecutive or non-consecutive slots. The time domain window includes at least two SLIVs if these at least two SLIVs are consecutive in the time domain and a gap between them is less than 14 symbols. If the first-step DCI and/or the second-step DCI are mis-detected or false-detected by the user equipment, the base station retransmits the corresponding step(s) based on their ACK/NACK received from the user equipment.

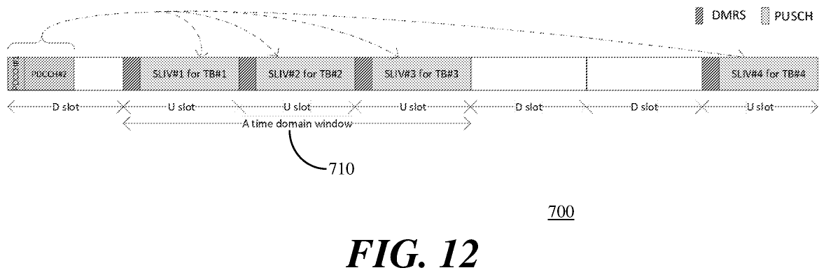

Referring to FIG. 12, an illustration 700 depicts joint channel estimation across multiple transport blocks for user equipment using the two-step DCI procedure (i.e., having two DCI in a slot). The time domain window 710 is defined to include three SLIVs for consecutive transport blocks received consecutively in the time domain (i.e., SLIV #1 for TB #1, SLIV #2 for TB #2, SLIV #3 for TB #3).

Joint channel estimation in accordance with determining at least a time domain window across multiple transport blocks for channel estimation based on an indication in the two-step DCI advantageously reduces PDCCH monitoring efforts by the user equipment resulting in power savings. In addition, such joint channel estimation enables a quick response if there is a failure of the two-step DCI in a slot. In addition, if every slot is assumed to have the same error probability of mis-detection/false-detection from user equipment side due to a specific reason, joint channel estimation across multiple transport blocks based on an indication in the two-step DCI in accordance with the present disclosure has a lower error probability than joint channel estimation across multiple transport blocks based on DCIs separately sent in multiple slots, while enabling all contents of multiple DCIs that schedule multiple transport blocks as joint channel estimation based on DCIs separately sent in multiple slots.

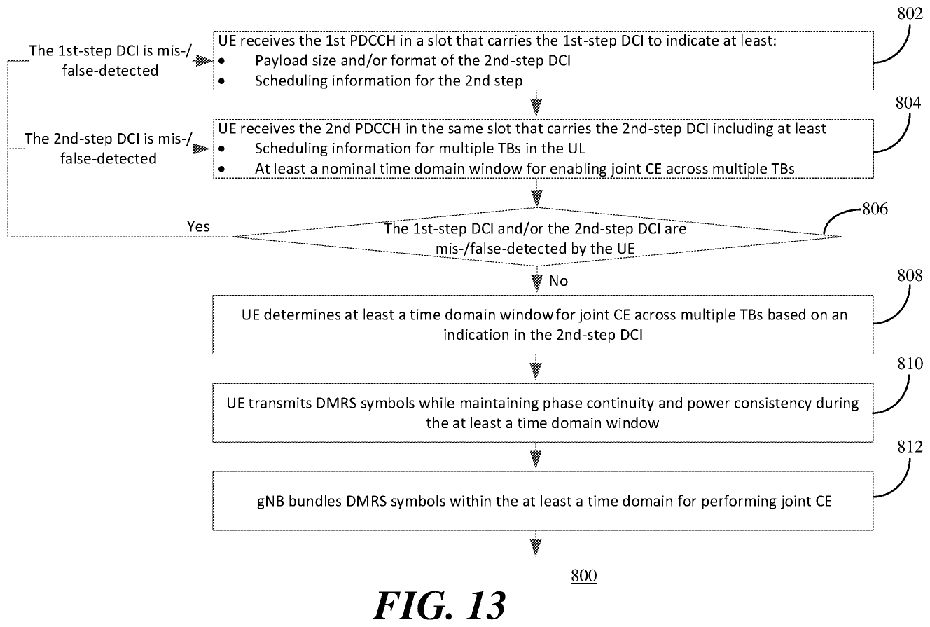

FIG. 13 depicts a flowchart 800 of the method for joint channel estimation across multiple transport blocks based on an indication in the two-step DCI in accordance with the present disclosure. At step 802, the user equipment receives the first PCCH in a slot that carries the first-step DCI to indicate at least a payload size and/or format of the second-step DCI and scheduling information for the second step. At step 804, the user equipment receives the second PCCH in a same slot that carries the second-step DCI including at least scheduling information for multiple transport blocks in the uplink and at least a nominal time domain window for enabling joint channel estimation across multiple transport blocks.

It is determined whether the first-step DCI or the second-step DCI are mis-detected or false-detected at step 806. If the first-step DCI is mis-detected or false-detected 806, steps 802 and 804 are repeated. If the second-step DCI is mis-detected or false-detected 806, step 804 is repeated. When both the first-step DCI and the second-step DCI are successfully detected 806, the user equipment determines at least a time domain window for joint channel estimation across multiple transport blocks based on an indication in the second-step DCI at step 808. At step 810, the user equipment transmits demodulation reference signal (DMRS) symbols while maintaining phase continuity and power consistency during the time domain window. Then, at step 812, the base station bundles the DMRS symbols within the time domain window for performing joint channel estimation.

If the user equipment drops some uplink symbol(s) or slot(s) due to other higher priority signals or channels, the user equipment determines and indicates at least an actual time domain window in uplink control information multiplexed with a PUSCH transmission of multiple transport blocks.

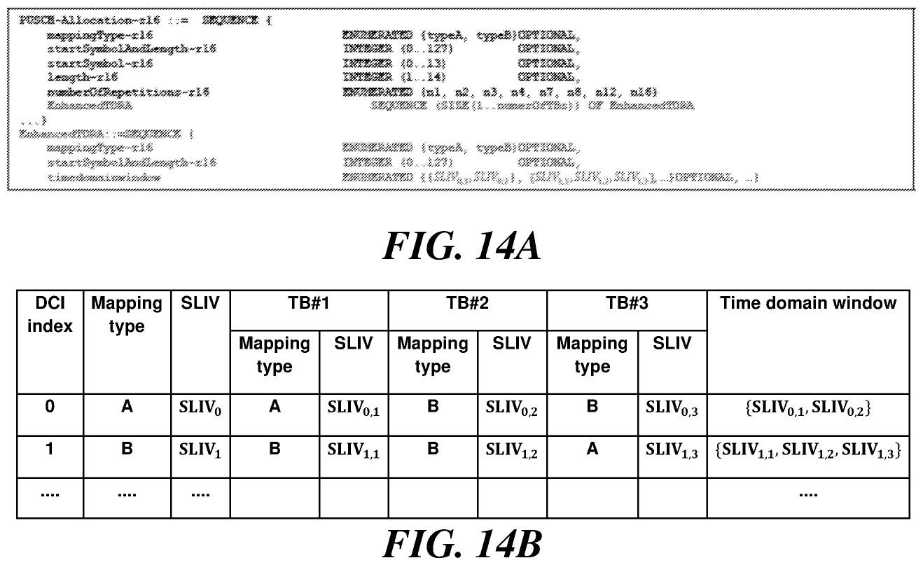

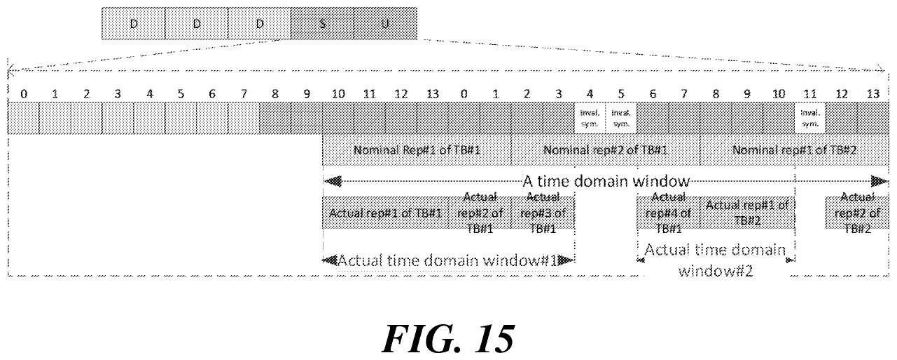

The time domain resource allocation (TDRA) table is enhanced and configured by radio resource control (RRC). The enhanced TDRA is added to enhance PUSCH-Allocation-r16 in PUSCH-TimeDomainResourceAllocation to configure the start and length indicator values (SLIVs) and mapping types for multiple transport blocks and a time domain window for joint channel estimation. A bit-field TDRA in the 2nd-step DCI, such as that shown in FIG. 14A, is used to indicate one of the indexes of the enhanced TDRA table depicted in FIG. 14B.

Instead of the user equipment receiving a PDCCH in step 804, the user equipment could receive receives a physical layer downlink shared channel (PDSCH) subsequently in symbols in the same slot that carries the second-step DCI, thereby allowing greater flexibility in configuring the PDSCH in terms of time-frequency resource allocation, modulation and coding schemes, and other parameters. In addition, both the first-step DCI and the second-step DCI can carry the same content, including at least details on scheduling information for multiple transport blocks in the uplink and a time domain window, to increase reliability. Carrying the same content in the first-step DCI and the second-step DCI is equivalent to the case where a DCI schedules multiple transport blocks and that DCI is repeated in the same slot. Alternatively, the two-step DCI may be repeated in an intra slot or in inter slots (such as repetition framework of PDCCH) to increase reliability in accordance with the present disclosure as shown in FIG. 15.

FIG. 15 illustrates DDSU format is used, where D is a downlink slot, S is a special slot, and U is an uplink slot. In special slot S and uplink slot U, repetitions of TB #1 and TB #2 are scheduled in accordance with the present disclosure by the two-step PDCCH within an actual time domain window. Due to procedures for handling collisions with invalid symbols, the user equipment determines several actual repetitions of TB #1 and TB #2, and determines the two actual time domain windows as shown.

In accordance with the present disclosure, the multiple transport blocks may be transmitted based on the same settings for at least antenna port, resource allocations, modulation and coding scheme (MCS), and uplink power. Also, the nominal time domain window and/or the actual time domain window may be a predefined period of PUSCH transmissions and at least the nominal time domain window may be configured by radio resource control (RRC). In addition, the solutions and variations described hereinabove for joint channel estimation may be applicable for the same frequency allocation in inter-slot frequency hopping procedures and numerous combinations of precoding schemes, multiple frequency hops, and multiple length of time domain windows may be applied.

In accordance with the present disclosure, joint channel estimation for PUSCH transmissions of multiple TBs and the nominal/actual time domain window are jointly enabled or disabled.

According to the network availability and capability of UEs, the multiple embodiments and their variations can be applied together in the network and can be applied for multiple transport blocks scheduled by RRC in configured grant (CG) type 1 in the uplink (UL), where each of multiple transport blocks are transmitted in one or more PUSCH transmissions. Although the described issues and solutions described hereinabove are mainly used for PUSCH, they are also applicable for PUCCH, PDCCH, or PDSCH.

Thus, it can be seen that the exemplary embodiments in accordance with the present disclosure provide communication apparatuses and communication methods for joint channel estimation for multiple transport blocks as described hereinabove for increased reliability and user equipment power saving.

The present disclosure can be realized by software, hardware, or software in cooperation with hardware. Each functional block used in the description of each embodiment described above can be partly or entirely realized by a LSI, such as an integrated circuit, and each process described in each embodiment may be controlled partly or entirely by the same LSI or a combination of LSIs. The LSI may be individually formed as integrated circuit chips, or one chip may be formed so as to include a part or all of the functional blocks. The LSI may include a data input and output coupled thereto. The LSI may be referred to as an integrated circuit (IC), a system LSI, a super LSI, or an ultra-LSI depending on a difference in the degree of integration. However, the technique of implementing an integrated circuit is not limited to the LSI and may be realized by using a dedicated circuit, a general-purpose processor, or a special purpose processor. In addition, a Field Programmable Gate Array (FPGA) that can be programmed after the manufacture of the LSI or a reconfigurable processor in which the connections and the settings of circuit cells disposed inside the LSI can be reconfigured may be used. He present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus.

The communication apparatus may comprise a transceiver and processing/control circuitry. The transceiver may comprise and/or function as a receiver and a transmitter. The transceiver, as the transmitter and receiver, may include a radio frequency (RF) module including amplifiers, RF modulators/demodulators and the like, and one or more antennas.

Some non-limiting examples of such a communication apparatus include a phone (e.g., cellular (cell) phone, smart phone), a tablet, a personal computer (PC) (e.g., laptop, desktop, netbook), a camera (e.g., digital still/video camera), a digital player (e.g., digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”. The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus may also include an infrastructure facility, such as a base station, an access point, and any other apparatus, device or system that communicates with or controls apparatuses such as those in the above non-limiting examples.

In the present disclosure, the downlink control signal (information) related to the present disclosure may be a signal (information) transmitted through PDCCH of the physical layer or may be a signal (information) transmitted through a MAC Control Element (CE) of the higher layer or the RRC. The downlink control signal may be a pre-defined signal (information).

The uplink control signal (information) related to the present disclosure may be a signal (information) transmitted through PUCCH of the physical layer or may be a signal (information) transmitted through a MAC CE of the higher layer or the RRC. Further, the uplink control signal may be a pre-defined signal (information). The uplink control signal may be replaced with uplink control information (UCI), the 1st stage sildelink control information (SCI) or the 2nd stage SCI.

In the present disclosure, the base station may be a Transmission Reception Point (TRP), a clusterhead, an access point, a Remote Radio Head (RRH), an eNodeB (eNB), a gNodeB (gNB), a Base Station (BS), a Base Transceiver Station (BTS), a base unit or a gateway, for example. Further, in side link communication, a terminal may be adopted instead of a base station. The base station may be a relay apparatus that relays communication between a higher node and a terminal. The base station may be a roadside unit as well.

The present disclosure may be applied to any of uplink, downlink and sidelink.

The present disclosure may be applied to, for example, uplink channels, such as PUSCH, PUCCH, and PRACH, downlink channels, such as PDSCH, PDCCH, and PBCH, and side link channels, such as Physical Sidelink Shared Channel (PSSCH), Physical Sidelink Control Channel (PSCCH), and Physical Sidelink Broadcast Channel (PSBCH).

PDCCH, PDSCH, PUSCH, and PUCCH are examples of a downlink control channel, a downlink data channel, an uplink data channel, and an uplink control channel, respectively. PSCCH and PSSCH are examples of a sidelink control channel and a sidelink data channel, respectively. PBCH and PSBCH are examples of broadcast channels, respectively, and PRACH is an example of a random access channel.

The present disclosure may be applied to any of data channels and control channels. The channels in the present disclosure may be replaced with data channels including PDSCH, PUSCH and PSSCH and/or control channels including PDCCH, PUCCH, PBCH, PSCCH, and PSBCH.

In the present disclosure, the reference signals are signals known to both a base station and a mobile station and each reference signal may be referred to as a Reference Signal (RS) or sometimes a pilot signal. The reference signal may be any of a DMRS, a Channel State Information-Reference Signal (CSI-RS), a Tracking Reference Signal (TRS), a Phase Tracking Reference Signal (PTRS), a Cell-specific Reference Signal (CRS), and a Sounding Reference Signal (SRS).

In the present disclosure, time resource units are not limited to one or a combination of slots and symbols, and may be time resource units, such as frames, superframes, subframes, slots, time slot subslots, minislots, or time resource units, such as symbols, Orthogonal Frequency Division Multiplexing (OFDM) symbols, Single Carrier-Frequency Division Multiplexing Access (SC-FDMA) symbols, or other time resource units. The number of symbols included in one slot is not limited to any number of symbols exemplified in the embodiment(s) described above, and may be other numbers of symbols.

The present disclosure may be applied to any of a licensed band and an unlicensed band.

The present disclosure may be applied to any of communication between a base station and a terminal (Uu-link communication), communication between a terminal and a terminal (Sidelink communication), and Vehicle to Everything (V2X) communication. The channels in the present disclosure may be replaced with PSCCH, PSSCH, Physical Sidelink Feedback Channel (PSFCH), PSBCH, PDCCH, PUCCH, PDSCH, PUSCH, and PBCH.

In addition, the present disclosure may be applied to any of a terrestrial network or a network other than a terrestrial network (NTN: Non-Terrestrial Network) using a satellite or a High Altitude Pseudo Satellite (HAPS). In addition, the present disclosure may be applied to a network having a large cell size, and a terrestrial network with a large delay compared with a symbol length or a slot length, such as an ultra-wideband transmission network.

An antenna port refers to a logical antenna (antenna group) formed of one or more physical antenna(s). That is, the antenna port does not necessarily refer to one physical antenna and sometimes refers to an array antenna formed of multiple antennas or the like. For example, it is not defined how many physical antennas form the antenna port, and instead, the antenna port is defined as the minimum unit through which a terminal is allowed to transmit a reference signal. The antenna port may also be defined as the minimum unit for multiplication of a precoding vector weighting.

While exemplary embodiments have been presented in the foregoing detailed description of the present disclosures, it should be appreciated that a vast number of variations exist. It should further be appreciated that the exemplary embodiments are only examples, and are not intended to limit the scope, applicability, operation, or configuration of the present disclosure in any way. Rather, the foregoing detailed description will provide those skilled in the art with a convenient road map for implementing exemplary embodiments, it being understood that various changes may be made in the function and arrangement of the STA communication apparatus and/or the AP communication apparatus described in the exemplary embodiments without departing from the scope of the present disclosure as set forth in the appended claims.

What is claimed is:

1. A communication apparatus comprising:
a transceiver, which in operation, receives control information triggering joint channel estimation across multiple transport blocks; and
circuitry, which in operation, determines one or more time domain windows for physical uplink shared channel (PUSCH) transmissions of the multiple transport block, and the transceiver, which in operation, transmits reference signals based on the one or more time domain windows.

2. The communication apparatus in accordance with claim 1, wherein the control information further includes multiple downlink control information (DCIs) to schedule the multiple transport blocks in the uplink, and wherein the circuitry determines the one or more time domain windows based on a linkage among the multiple DCIs.

3. The communication apparatus in accordance with claim 2, wherein the multiple DCIs are received in a particular order and each of the multiple DCIs includes an index.

4. The communication apparatus in accordance with claim 1, wherein the one or more time domain windows are determined based on dropping one or more uplink symbols or slots for transmission of higher priority signals or channels and/or any unsuccessful detection of the multiple DCIs.

5. The communication apparatus in accordance with claim 1, wherein the control information is indicated by one or more of a downlink control information (DCI), a medium access control element (MAC CE), and a radio resource control (RRC).

6. The communication apparatus in accordance with claim 1, wherein each of the one or more time domain windows includes a subset combination of a total number of PUSCH transmissions from the multiple TBs.

7. The communication apparatus in accordance with claim 2, wherein when the circuitry unsuccessfully detects any of the multiple DCIs, the circuitry determines the one or more time domain windows for joint channel estimation across a subset of the multiple TBs.

8. The communication apparatus in accordance with claim 2, wherein the actual one or more time domain windows for the joint channel estimation determined by the circuitry are shorter than one or more time domain windows which are provided to the communication apparatus based on the control information.

9. The communication apparatus in accordance with claim 8, wherein the circuitry indicates the actual one or more time domain windows in a uplink control information that is multiplexed in at least one of the PUSCH transmissions.

10. The communication apparatus in accordance with claim 1, wherein the physical layer uplink shared channel (PUSCH) transmissions include multiple transmission types.

11. The communication apparatus in accordance with claim 1, wherein each length of the one or more time domain windows is the same as a length of frequency hopping with the same frequency allocation.

12. The communication apparatus in accordance with claim 1, wherein each length of the one or more time domain windows is different from a length of frequency hopping with the same frequency allocation.

13. The communication apparatus in accordance with claim 1, wherein the circuitry and the transceiver are further configured apply same settings for at least antenna port, resource allocations, modulation coding and scheme, and transmit power for transmission of the multiple TBs based on the control information.

14. A base station comprising:
a transceiver, which in operation, transmits control information to trigger joint channel estimation across multiple transport blocks and receives reference signals based on one or more time domain windows for physical uplink shared channel (PUSCH) transmissions of the multiple transport block; and
circuitry, which in operation, enables joint channel estimation across multiple transport blocks based on the reference signals.

15. A communication method comprising:
receiving control information triggering joint channel estimation across multiple transport blocks;
determining one or more time domain windows for physical uplink shared channel (PUSCH) transmissions of the multiple transport blocks; and
transmitting reference signals based on the one or more time domain windows.
